(19) United States
(12) Patent Application Publication
(10) Pub. No.: US 2015/0232241 A1
(43) Pub. Date: Aug. 20, 2015

(54) MULTI-LAYER ONE-WAY VALVE FOR PACKAGING

(71) Applicant: CCL LABEL, INC., East Lansing,, MI (US)

(72) Inventors: David R. Gardner, Strongsville, OH (US); Sarang Bhawalkar, Lakewood, OH (US); William G. Hartman, North Royalton, OH (US); Anne Shim, Hudson, OH (US)

(21) Appl. No.: 14/433,124

(22) PCT Filed: Oct. 3, 2013
(86) PCT No.: PCT/US13/63222

§ 371 Date: Apr. 2, 2015

Related U.S. Application Data
(60) Provisional application No. 61/709,214, filed on Oct. 3, 2012.

(51) Int. Cl. B65D 51/16; F16K 17/164

(52) U.S. Cl. CPC B65D 51/16; F16K 17/164

(57) ABSTRACT

A multi-layer control device or one-way valve (100) includes: a first layer (10) having at least one first opening (12) formed therein; and a second layer (20). The first and second layers are joined together such that at least one channel (24) is defined therebetween, which channel selectively permits gas flow from the first opening out of the device/valve. In operation, the valve selectively opens to permit gas flow through the channel in response to a pressure differential on opposing sides of the valve, wherein the pressure differential sufficient to open the valve (ΔPₒ) dynamically varies over time. Suitably, a material is arranged in the channel which experiences a change that precipitates the dynamic variation of ΔPₒ.

### REFERENCE TO RELATED APPLICATIONS

The present application claims the benefit of U.S. Provisional Application No. 61/709,214 entitled “Multi-Layer One-Way Valve for Packaging” filed on Oct. 3, 2012, which is incorporated herein by reference in its entirety.

### FIELD

The present inventive subject matter relates generally to the art of fluid and/or gas control devices, such as valves. Particular but not exclusive relevance is found in connection with one-way valve assemblies, e.g., that provide a hermetic and/or fluid resistant seal but which still allow for the controlled expulsion of gas and related pressure from an interior of a bag, receptacle, container or other packaging. Accordingly, the present specification makes specific reference thereto. It is to be appreciated however that aspects of the present inventive subject matter are also equally amenable to other like applications.

### BACKGROUND

Various types of packaging options are available today and are often used by consumers, industries, and numerous retailers to store food and other consumables for later use or consumption. It is often desirable for specific food retailers to present a product that appears attractive to consumers, e.g., to increase product sales and promote a particular brand.

Coffee beans have a tendency to release a significant amount of gas following the roasting process, even after the coffee beans have already been placed in a sealed bag, container or other like packaging. The presence of excessive gas and/or pressure within a sealed container or package may result in the container or package bulging and changing its shape or even bursting which can make the product unattractive to consumers and may impact the manufacturer by decreasing the amount of sales of those coffee beans.

Accordingly, one-way valves have heretofore been applied to packages containing roasted coffee beans in order to release excess gas from the interior of the container to the external environment, while inhibiting the flow of external gas and/or contaminates from the external environment into the otherwise sealed container or package. Such valves generally open in response to a small or minimal (i.e., near zero) pressure differential ΔP between the package interior and the external environment. That is to say, such valves generally remain open until the interior pressure is substantially equalized with the exterior pressure. Moreover, the flow rate of gas through the valve tends to be linear with respect to the aforementioned pressure differential. While generally useful, such valves can be undesirable in some instances and/or otherwise exhibit certain limitations.

For example, roasted coffee beans are commonly packaged at a relatively low altitude which tends to have a higher ambient external pressure as compared to higher altitudes, e.g., at which airplanes shipping the packaged coffee may fly or shipping routes over mountain ranges. When the roasted coffee is initially packaged (e.g., at or near ground level), the pressure differential between the interior and exterior of the otherwise sealed packaging causes the valve to open and allow gas to escape the package. Accordingly, the pressure differential drops as the gas escapes and the pressure inside the packaging decreases. At some point, the pressure differential is no longer sufficient to keep the valve open, and the valve closes. Commonly, some gas remains trapped in the packaging at this point, and therefore some degree of interior pressure is retained. However, when the packaged coffee is trucked over mountains or even shipped by air freight, at the relatively higher altitude the external pressure experienced by the package may be relatively lower than the external pressure at which the coffee was initially packaged. In this case, the pressure differential may again exceed a threshold at which point the valve reopens, thereby allowing additional gas that remained in the package to again be expelled. Accordingly, the pressure inside the package is lowered yet further until the valve once again closes. Finally, when the package is again brought to a lower altitude with a correspondingly higher external pressure, the container or package may appear compressed or crushed (sometime referred to as “bricked”), e.g., due to the relatively lower interior pressure of the package versus the exterior atmospheric pressure that was achieved as a result of its shipping over a higher altitude route. In some instances, consumers may be displeased with the bricked appearance of the package and may therefore be less inclined to purchase the product. This can of course be undesirable from the view point of the coffee manufacturer and/or retailer. A further way pressure can increase is due to an increase in temperature during shipping and or storage of the product. As explained by the Ideal Gas Law, pressure increases proportionally with temperature. When the pressure inside a package increases, the valve will open and release the increased pressure and after the package cools the pressure will proportionally decrease with less volume of gas creating a compressed (“bricked”) package.

Accordingly, a new and/or improved valve is disclosed which addresses the above-referenced problem(s) and/or others.

### BRIEF SUMMARY

This summary is provided to introduce concepts related to the present inventive subject matter. The summary is not intended to identify essential features of the claimed subject matter nor is it intended for use in determining or limiting the scope of the claimed subject matter. The embodiments described below are not intended to be exhaustive or to limit the invention to the precise forms disclosed in the following detailed description. Rather, the embodiments are chosen and described so that others skilled in the art may appreciate and understand the principles and practices of the present inventive subject matter.

In accordance with one embodiment, a one-way valve includes: a plurality of layers arranged one over another; and a path extending through the layers. The valve selectively opens to permit a flow through the valve via the path in response to a pressure differential on opposing sides of the valve being sufficient to open the valve, wherein the pressure differential sufficient to open the valve dynamically varies over time.

In one suitable embodiment, the foregoing valve has an opening pressure differential at a first time in the range of approximately 0.01 psi to approximately 0.4 psi, and second opening pressure differential at a second time different from the first time in the range of approximately 0.4 psi to approximately 10.0 psi. Optionally, an amount of time which elapses between the first time and the second time is in the range of approximately 1 day to approximately 14 days.

In accordance with a further embodiment, the valve may further include a material arranged in the path, the material experiencing a change over time which in turn alters how much pressure differential is sufficient to open the valve. For example, the change experienced by the material may be a phase change, a change in viscosity or a change in tackiness.

In one suitable embodiment of the valve, the material may be a multi-part material including a first part, a crosslinker and a catalyst, wherein the material has a first viscosity and over time parts thereof react to achieve a second viscosity greater than the first viscosity (a measure of the resistance of a fluid which is being deformed by either shear stress or tensile stress).

In another suitable embodiment of the valve, the material is an adhesive that has a first tackiness and dries over time to achieve a second tackiness greater than the first tackiness (e.g., as measured by Loop Tack ASTM D6195).

In yet another suitable embodiment of the valve, the material is a hygroscopic material. For example, the hygroscopic material may be xanthan gum, silica gel or poly(vinyl alcohol).

In accordance with another embodiment, the change experienced by the material may be initiated or encouraged by exposure to at least one of heat, light or moisture.

In accordance with still another embodiment, a package is provided with the foregoing valve.

Numerous advantages and benefits of the inventive subject matter disclosed herein will become apparent to those of ordinary skill in the art upon reading and understanding the present specification. It is to be understood, however, that the detailed description of the various embodiments and specific examples, while indicating preferred and other embodiments, are given by way of illustration and not limitation. Many changes and modifications within the scope of the present invention may be made without departing from the spirit thereof, and the invention includes all such modifications.

### BRIEF DESCRIPTION OF THE DRAWINGS

The following detailed description makes reference to the figures in the accompanying drawings. However, the inventive subject matter disclosed herein may take form in various components and arrangements of components, and in various steps and arrangements of steps. The drawings are only for purposes of illustrating exemplary, preferred and/or other embodiments and are not to be construed as limiting. Further, it is to be appreciated that the drawings may not be to scale.

FIG. 1 is a graph showing a dynamically changing opening pressure of an exemplary valve in accordance with aspect of the present inventive subject matter.

FIG. 2 is a diagrammatic illustration showing a cross-section of an exemplary valve in accordance with aspect of the present inventive subject matter, the cross-section being taken along section line A-A, e.g., as shown in FIGS. 2a and 2b.

FIGS. 2a and 2b are diagrammatic illustrations showing opposing first and second sides of a base layer from the valve illustrated in FIG. 1.

FIGS. 3a and 3b are diagrammatic illustrations showing opposing first and second sides of a top layer from the valve illustrated in FIG. 1.

FIG. 4 is a diagrammatic illustration showing the valve of FIG. 1 applied to a package.

FIG. 5 includes graphs showing experimental data for exemplary sample valves made in accordance with aspect of the present inventive subject matter.

FIG. 6 includes graphs showing experimental data for more exemplary sample valves made in accordance with aspect of the present inventive subject matter

### DETAILED DESCRIPTION

The apparatuses and methods disclosed in the present specification are described in detail by way of examples and with reference to the figures. Unless otherwise specified, like numbers in the figures indicate references to the same, similar or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to the figure.

The present inventive subject matter relates generally to a multi-layer fluid control device or one-way valve that allows for the expulsion of air, gas and/or other unwanted components from an interior of an otherwise sealed container or package, while providing a protective seal that prevents or inhibits unwanted air, gas, moisture and/or other components or contaminates found in an exterior of the container or package from entering the interior thereof. Suitably, the protective seal provided by the multi-layer control device or one-way valve may be a hermetic or water resistant seal which permits fluid and/or gas flow therethrough in one direction (e.g., from an interior to an exterior of a package), while preventing or inhibiting fluid and/or gas flow therethrough in an opposite direction (e.g., from an exterior to an interior of a package). Accordingly, the outlet of gas from an interior of a package fitted with such a valve protects against an undesirable build-up of excessive pressure inside the otherwise sealed package.

Suitably, the valve only opens (e.g., to release gas from an interior of the package) when the pressure differential (ΔP) between the package's internal pressure (Pᵢ) and the ambient external pressure (Pₑ) exceeds a given opening threshold (Tₒ). That is to say, the valve only opens when ΔP=Pᵢ−Pₑ>Tₒ, thereby allowing gas to flow out through the valve from an interior of the otherwise sealed package to an exterior thereof. The pressure differential (ΔP) at which the valve opens shall be referred to herein as the opening pressure (ΔPₒ). In accordance with one aspect of the present inventive subject matter, the opening pressure (ΔPₒ) of the valve and/or the opening threshold (Tₒ) dynamically changes over time. For example, at a first time (t₁) the opening pressure (ΔPₒ) may be a first value (ΔP₁), and at a second later time (t₂) the opening pressure (ΔPₒ) may be a second value (ΔP₂) which is different from the first value (ΔP₁).

In one embodiment, the valve is constructed with a tortuous, straight or other suitable path or channel defined therethrough. In practice, when the valve is open, the path/channel is essentially open and/or unblocked such that gases and/or other fluids or liquids are permitted to escape the otherwise sealed package by flowing essentially one way out through the path/channel formed in the valve to an exterior of the package. Conversely, when the valve is closed, the path/channel is essentially closed and/or substantially blocked such that flow through the path/channel formed in the valve is essentially blocked and/or substantially inhibited. Suitably, at least one material is arranged in the path/channel which dynamically changes the opening pressure (ΔPₒ) of the valve over time. Suitably, the material experiences and/or undergoes a change which precipitates a change of the opening pressure (ΔPₒ). Optionally, the material may experience a phase change, a change in viscosity, a change in tackiness, a change in crosslink density or a change in its storage and/or loss moduli. The change in the material may be the result of a chemical reaction and/or curing of the material and/or the change may be initiated by exposure of the material to heat, light and/or moisture and/or the change may occur with the elapsing of time and/or the change may occur as a result of a solvent (including water) being evaporated and/or driven off from the material or other like drying of the material.

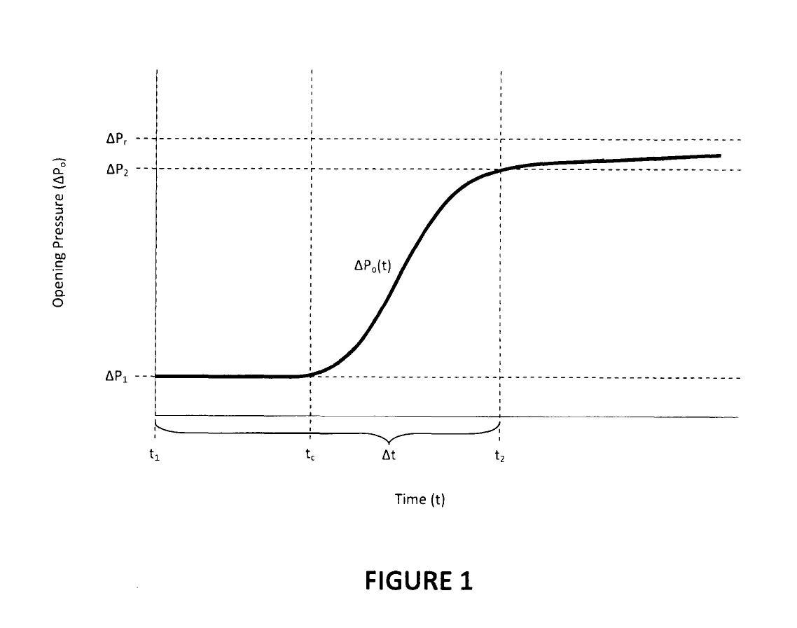

Referring now to the figures and initially to FIG. 1, there is shown a graph illustrating an exemplary dynamically changing opening pressure (ΔPₒ) which one exemplary embodiment of the presently disclosed valve may suitable exhibit. As shown, time (t) is represented on the horizontal axis, and opening pressure (ΔPₒ) is represented on the vertical axis. In the illustrated embodiment, at time (t₁) the valve has an initial opening pressure (ΔP₁). Later, at time (t₂) the valve has a different (i.e., higher in this example) opening pressure (ΔP₂). As shown, the opening pressure (ΔPₒ) increases over time and may approach but not reach a pressure differential (ΔPᵣ) at which the package would tend to rupture or burst absent the opening of the valve. For example, ΔP, may be in the range of approximately 3 psi to approximately 8 psi. Suitably, after a sufficient lapse of time, the opening pressure (ΔPₒ) may again stabilize or cease to substantially change further. In this manner, for example, the valve helps protect against unwanted deformity of a package containing roasted coffee beans or other like offgassing products, by allowing a suitable amount of gas to be released from the interior of the package when it is initially packaged at a first relatively higher external pressure (e.g., at or near a ground level altitude), while limiting an additional amount of gas from being released from the interior of the package when it is subsequently exposed to a second relatively lower external pressure (e.g., when the package is shipped over a higher altitude route, such as by airfreight or over a mountain).

As shown in FIG. 1, the opening pressure (ΔPₒ) begins to rise or change at some time t_{c} after t=0. However, in practice, the time after which the opening pressure (ΔPₒ) starts changing is suitably anywhere between 0 hours and Δt hours, i.e., t_{c} may reside anywhere between 0 and t₂.

In one alternate embodiment, the valve may eventually close essentially permanently and/or altogether after a period of time, e.g., due to the change experienced by the material arranged in the path/channel. As shown in FIG. 1, the ΔPₒ eventually levels off (i.e., it approaches but does not exceed ΔPᵣ), e.g., after time t₂. Alternately, however, in an embodiment where the valve eventually closes essentially permanently and/or altogether, ΔPₒ may continue to rise, e.g., above ΔPᵣ. In yet another embodiment, the change experienced by the material arranged in the path/channel may be reversible and hence the dynamically variable opening pressure may be selectively increased and/or decreased as desired.

In one exemplary embodiment, the initial opening pressure (ΔP₁) is in the range of approximately 0.05 psi to approximately 1.0 psi. In another exemplary embodiment, ΔP₁ is in the range of approximately 0.1 psi to approximately 0.5 psi. In still a further exemplary embodiment, ΔP₁ is in the range of approximately 0.1 psi to approximately 0.4 psi. Suitably, the subsequent opening pressure (ΔP₂) is in the range of approximately 0.4 psi to approximately 15 psi. In another exemplary embodiment, ΔP₂ is in the range of approximately 0.4 psi to approximately 12 psi. In still a further exemplary embodiment, ΔP₂ is in the range of approximately 0.4 psi to approximately 10 psi. In practice, the subsequent opening pressure (ΔP₂) is reached after an elapsed time (Δt) which is generally the time between t₁ and t₂ (i.e., Δt=t₂−t₁). Suitably, the elapsed time (Δt) is in the range of approximately 1 hour to approximately 28 days. In another exemplary embodiment, Δt is in the range of approximately 5 hours to approximately 17 days. In still a further exemplary embodiment, Δt is in the range of approximately 5 hours to approximately 14 days.

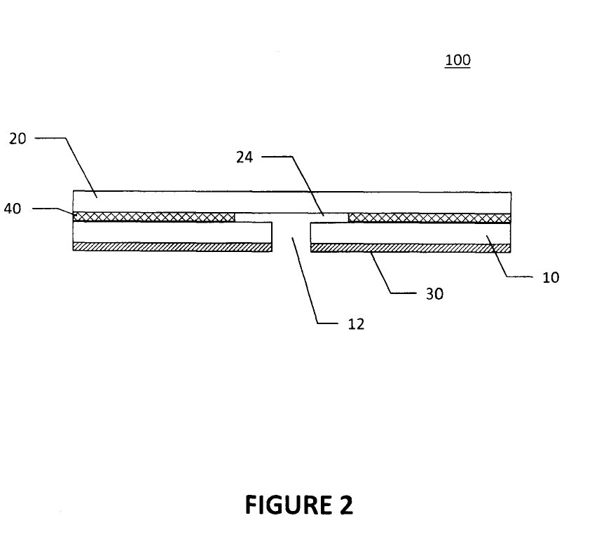

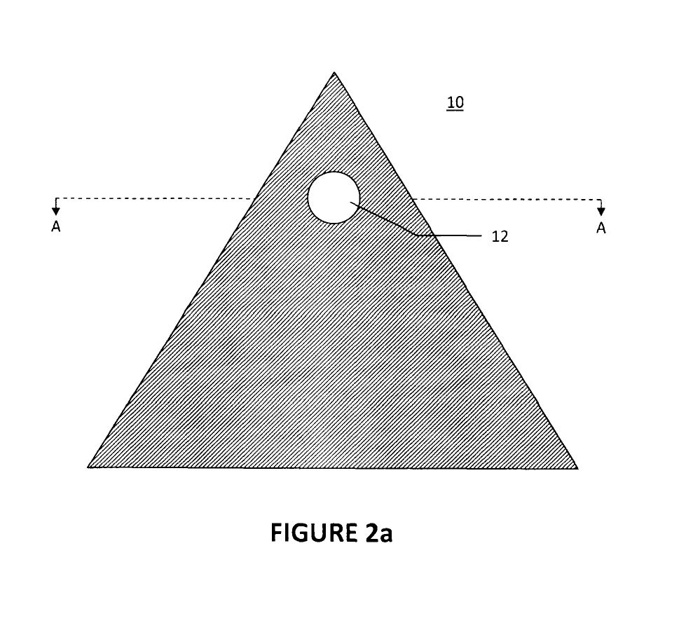

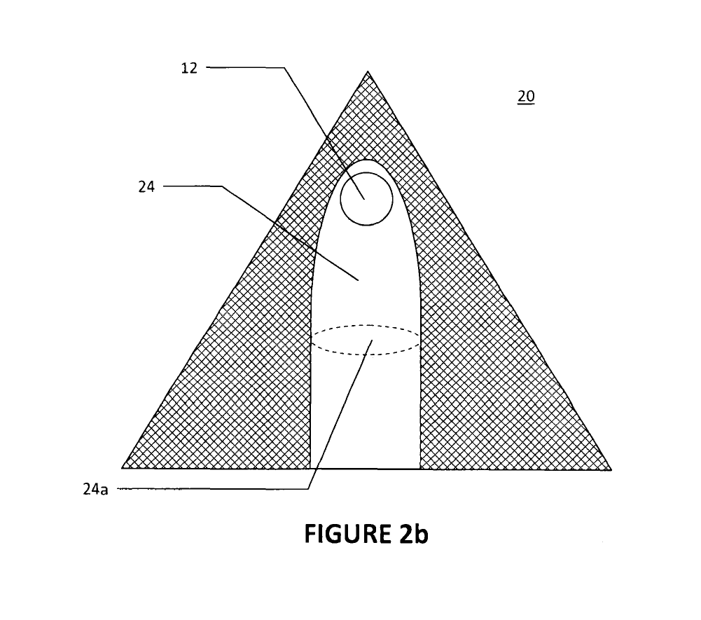

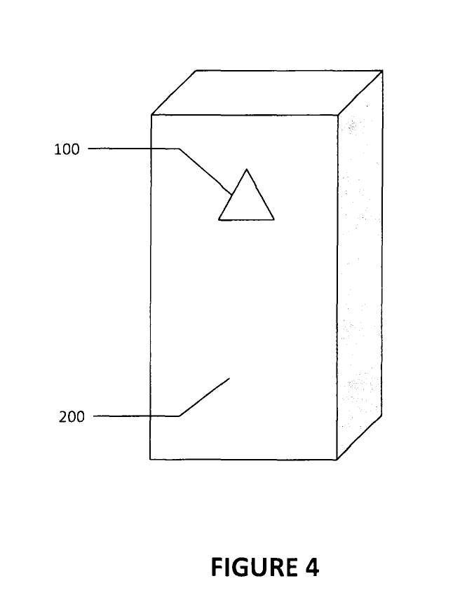

Referring now to FIG. 2, there is shown an exemplary multi-layer control device or one-way valve 100 suitable for practicing aspects of the present inventive subject matter and exhibiting the aforementioned operative properties. As illustrated, the valve 100 includes a base layer 10 and a top layer 20 joined together by respective layers or coatings of adhesive or the like. In particular, a first layer or coating of adhesive 30 resides on a first or underside of the base layer 10; and a second layer or coating of adhesive 40 resides between a second or topside of the base layer 10 (i.e., opposite the first or underside of the base layer 10) and a first or underside of the top layer 20. As can be appreciated, the second layer of adhesive 40 joins the base and top layers 10 and 20 together. Suitably, the first layer of adhesive 30 is used to attach the valve to a wall or surface of an otherwise sealed or closed receptacle, container or package 200, e.g., as shown in FIG. 4.

With reference now to FIG. 2a, there is shown the first or underside of the base layer 10. In the illustrated embodiment, an aperture, opening or hole 12 is formed in the base layer 10. The hatching in FIG. 2a indicates the area where the first layer of adhesive 30 resides on the first or underside of the base layer 10. In this case, the first layer of adhesive 30 may be substantially coextensive with the entire first or underside of the base layer 10.

With reference now to FIG. 2b, there is shown the second or topside of the base layer 10. The hatching in FIG. 2b indicates the area where the second layer of adhesive 40 resides with respect to the second or topside of the base layer 10. As shown, the adhesive layer 40 may be essentially coextensive with the entire second or topside of the base layer 10 except for an adhesive-free swath or strip extending from the hole 12 to a perimeter of the base layer 10. Accordingly, when the top layer 20 is positioned atop or otherwise in contact with the adhesive layer 40, there is defined a path or channels 24 extending from the hole 12 to a periphery of the valve 100. In this way, the hole 12 is in selective fluid communication with the periphery of the valve 100 via the channel 24.

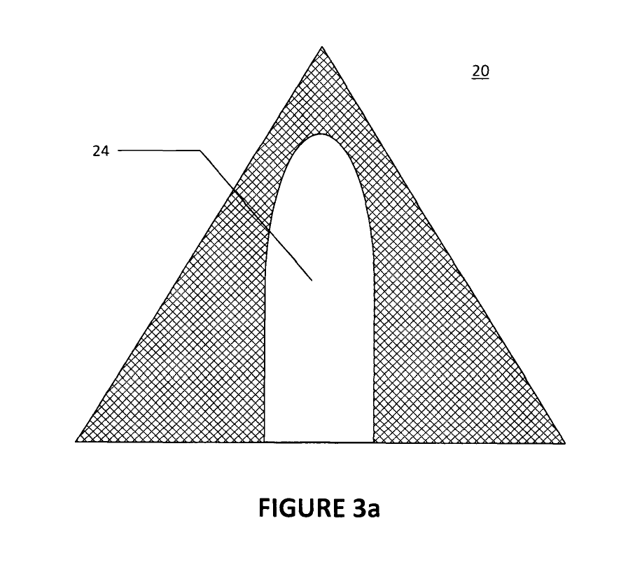

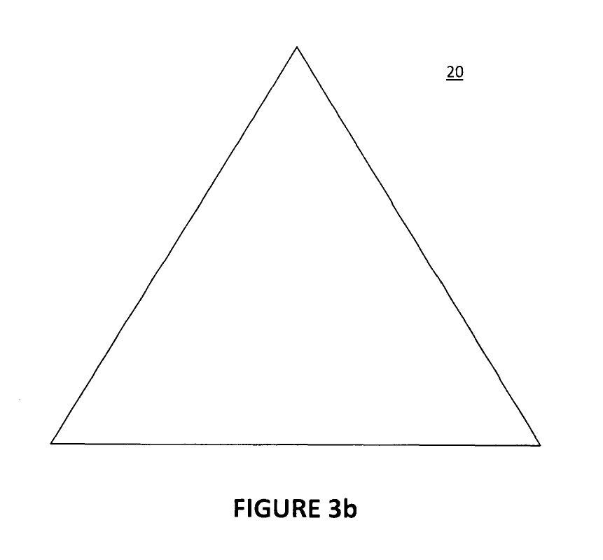

With reference now to FIGS. 3a and 3b, there are shown respectively the first or underside of the top layer 20 and an opposing second or topside of the top layer 20. The hatching in FIG. 4a indicates the area where the second layer of adhesive 40 resides with respect to the first or underside of the top layer 20.

Suitably, any one or both of the adhesive layers 30 and/or 40 is optionally a Pressure Sensitive Adhesive (PSA), e.g., which is generally recognized as safe (GRAS) for indirect food packaging. The adhesive may be a form of an epoxy or acrylic or rubber based adhesive which is a versatile adhesive that can be used to join a variety of materials. Additionally, polyvinyl acrylate and toughened acrylics may also serve as suitable adhesives for selected embodiments. It is also contemplated that the adhesive layers may be a type of permanent adhesive in order to facilitate permanent adhesion of respective components and/or elements.

In practice, the base and top layers 10 and 20 of the valve 100 are constructed out of suitably flexible films or sheets of material. Without limitation, one suitable material includes, e.g., a polyester such as polyethylene terphthalate (PET). Optionally, any one or both of the base and top layers 10 and 20 may be constructed out of the same type of material or dissimilar materials may be used for any one or both of the aforementioned layers. In one embodiment, the top layer 20 may be constructed out of a foil laminate.

In one suitable embodiment, the valve 100 may be constructed and/or assembled by coating or otherwise applying the respective adhesive layers 20 and/or 30 to one or more of the sides of the base and/or top layers 10 and/or 20 on which it resides and then laminating, sandwiching and/or stacking the layers together. Of course, as can be appreciated from the foregoing description of the figures, one or more of the various adhesive layers are discontinuous. Accordingly, such discontinuous adhesive layers may be achieved via pattern coating or the like. Suitably, multiple valves may be formed in webs or sheets of material that make up the various layers, and individual valves die cut or otherwise removed therefrom. Likewise, the hole 12 may be similarly die cut or otherwise formed in the respective material layer.

In use (e.g., as shown in FIG. 4), the valve 100 is suitably affixed to a wall or surface of the package 200 via the adhesive layer 20. Generally, the otherwise sealed package 200 will have or be provided one or more evacuation ports (i.e., holes, openings, apertures, etc.) in the wall and/or surface to which the valve 100 is affixed. When attaching the valve 100 to the package 200, suitably these ports are aligned and/or otherwise arranged to be in fluid communication with the hole 12 of the base layer 10. Suitably, the package 200 may contain roasted coffee beans or another offgassing product.

Returning attention to FIG. 2b, suitably the path/channel 24 is supplied with an amount of material, e.g., in the region 24a indicated by the dashed line. As described herein, the material arranged in the region 24a is largely responsible for dynamically changing the opening pressure (ΔPₒ) of the valve 100 over time. Suitably, as mentioned earlier, at some point or over time, the material experiences and/or undergoes a change which precipitates a change of the opening pressure (ΔPₒ). Optionally, the change experience by the material may be a phase change, a change in viscosity, a change in tackiness, a change in crosslink density or a change in its storage and/or loss moduli. The change in the material may be the result of a chemical reaction and/or curing of the material and/or the change may be initiated by and/or aided by exposure of the material to heat, light, air and/or moisture and/or the change may occur with the elapsing of time and/or as a result of a diffusion of the material or parts of the material and/or the change may occur as a result of a solvent (including water) being evaporated and/or driven off from the material or other like drying of the material.

In operation, the valve 100 is generally closed, e.g., when ΔP is less than a closing pressure threshold (T_{c}). In this state, due in part to the flexible nature of the various layers 10 and 20, the channel 24 will be collapsed. That is to say, when the valve 100 is in the closed state, the first or underside of the top layer 20 will sag, cling to and/or otherwise contact the second or topside of the base layer 10 along the region in which the channel 24 is otherwise defined, thereby preventing or inhibiting gas flow or fluid communication between the hole 12 and the periphery of the valve 100. Suitably, the material deposited in the channels 24 facilitates sealing-off of the channels 24 in this case.

Conversely, when ΔP>Tₒ for example, the valve 100 opens as gas is expelled from an interior of the otherwise sealed package 200. Suitably, the expelled gas flows out the evacuation port or ports in the wall or surface of the package 200 through the valve 100 to an exterior environment outside the package 200. More specifically, the pressure (Pᵢ) inside the package 200 overcomes the external pressure (Pₑ) and other forces acting to collapse, seal and/or otherwise close the channel 24 so as to open the aforementioned channel. That is to say, the first or underside of the top layer 20 will become unseated and/or separated from the second or topside of the base layer 10 in the region where the channel 24 is defined, thereby permitting gas flow or fluid communication from the hole 12 to the periphery of the valve 100 via the channel 24. Of course, due to changes experience by the material in the region 24a, the pressure differential (ΔP) sufficient to achieve the foregoing results and/or opening of the channel 24 and/or valve 100 is dynamically altered over time.

For example, the material in the region 24a may undergo a phase change, e.g., from a liquid to a solid. Accordingly, the opening pressure (ΔPₒ) may increase correspondingly. That is to say, while a liquid, the opening pressure may be (ΔP₁), however when the material changes to a solid, the opening pressure may increase to (ΔP₂). More specifically, while the material is in liquid form, it may permit the path or channel 24 to open and/or allow gas or the like to escape therethrough. Conversely, when changed to a solid, the material may completely block or nearly completely block the path or channel 24 or prevent or strongly resist opening of the channel 24, thereby significantly increasing the opening pressure or closing off the valve 100 completely or nearly completely. In another embodiment, a liquid material may undergo a change or increase in viscosity. The higher viscosity liquid accordingly inhibits air flow through the channel 24 by a greater amount and/or increases a resistance of the channel 24 to opening as compared when the liquid has a lower viscosity. In yet another embodiment, the material in the region 24a may undergo a change in tackiness over time. At a first lower tackiness level, the material in the region 24a tends to hold the bottom of the top layer 20 to the top of the base layer 10 in the region of the channel 24 with a first relatively weak grip, thereby causing the valve 100 to have a first relative smaller opening pressure (ΔP₁). At the second higher tackiness level, the material in the region 24a tends to hold the bottom of the top layer 20 to the top of the base layer 10 in the region of the channel 24 with a second relatively stronger grip, thereby causing the valve 100 to have a second relatively greater opening pressure (ΔP₂).

In one suitable embodiment, the material is a two part composition or system that crosslinks and/or otherwise reacts over time resulting in an increased viscosity/phase change. For example, the two part system may include a base part such as silicon oil, epoxy, polyurethane, ester, acid chloride or the like, along with a crosslinker, catalyst and/or other component that is reactive with the base part. For example, platinum, tin or other metal may act as the catalyst. Suitably, the viscosity change/phase change resulting from the reaction produces a change in the opening pressure (ΔPₒ) of greater than 1 psi over a period of less than a week. In a more particular embodiment, the opening pressure (ΔPₒ) increases from approximately around 0.3 psi to greater than 2.5 psi in 19 hours. In one embodiment, the viscosity change is the result of additional curing, e.g., a double bond in a silicone part may react with an Si—H bond in a crosslinker catalyzed by platinum. In another embodiment, the viscosity change may result from additional condensation curing, e.g., including a reaction between the —OH group in a silicone part and a silicic acid ester catalyzed by tin with an alcohol as the byproduct. Suitably, the reaction/crosslinking may be initiated and/or aided by the application of heat, ultraviolet or other light, moisture, etc. In suitable embodiments, the material may undergo a phase change, e.g., from liquid to solid. In one suitable embodiment, offgassing from roasted coffee or the like in the package 200 can expose the material arranged in the region 24a to heat and/or moisture, which in turn initiates the reaction/crosslinking and/or otherwise encourages the same to thereby increase the viscosity of the material and correspondingly increase the opening pressure (ΔPₒ) of the valve 100. In one exemplary embodiment of this type, the opening pressure (ΔPₒ) increased from approximately 0.3 psi to approximately 0.7 psi in about 20 hours at room temperature (i.e., 25° C.). In another example, the opening pressure increased to approximately 1.0 psi in about 20 hours at 40° C.

In another embodiment, the material arranged in the region 24a is an adhesive, e.g., a pressure sensitive adhesive (PSA). Initially, the adhesive is substantially wet and has a relatively low tack and hence the resulting opening pressure (ΔPₒ) is relatively low. Suitably, the adhesive is an emulsion-based adhesive that is soluble in water or another non-volatile medium. In practice, however, other solvents may be used. Over time, the solvent (be it water or otherwise) is evaporated or otherwise driven-off or the adhesive is allowed to dry. Accordingly, the tackiness of the adhesive increases and the opening pressure (ΔPₒ) of the valve 100 correspondingly increases. Optionally, an additive, e.g., such as propylene glycol/poly(ethylene glycol), may be included to slow the drying rate of the adhesive. Again, heat from roasted coffee or the like in the package 200 may initiate the drying and/or otherwise encourage the same. In one example of this type, the opening pressure increased to greater than 2.5 psi after a day and a half.

In still another embodiment, a hygroscopic material is arranged in the region 24a. Initially, the material can be relatively dry and hence have a first volume or size, which in turns results in an initial opening pressure (ΔPₒ) which is relatively low. In time, the hygroscopic material may be exposed to moisture which is absorbed thereby. Accordingly, as the hygroscopic material absorbs the moisture, the material tends and/or wants to swell and/or increase in volume, which in turn raises the opening pressure (ΔPₒ) of the valve 100. Examples of suitable hygroscopic materials include but are not limited to xanthan gum, silica gel and poly(vinyl alcohol). Other suitable material includes, without limitation, a crosslinked gel or partial polymer with optional pendant groupings and/or optional side chains. Suitably, moisture to swell the hygroscopic material may come from offgassing produced by roasted coffee of the like in the packaging 200.

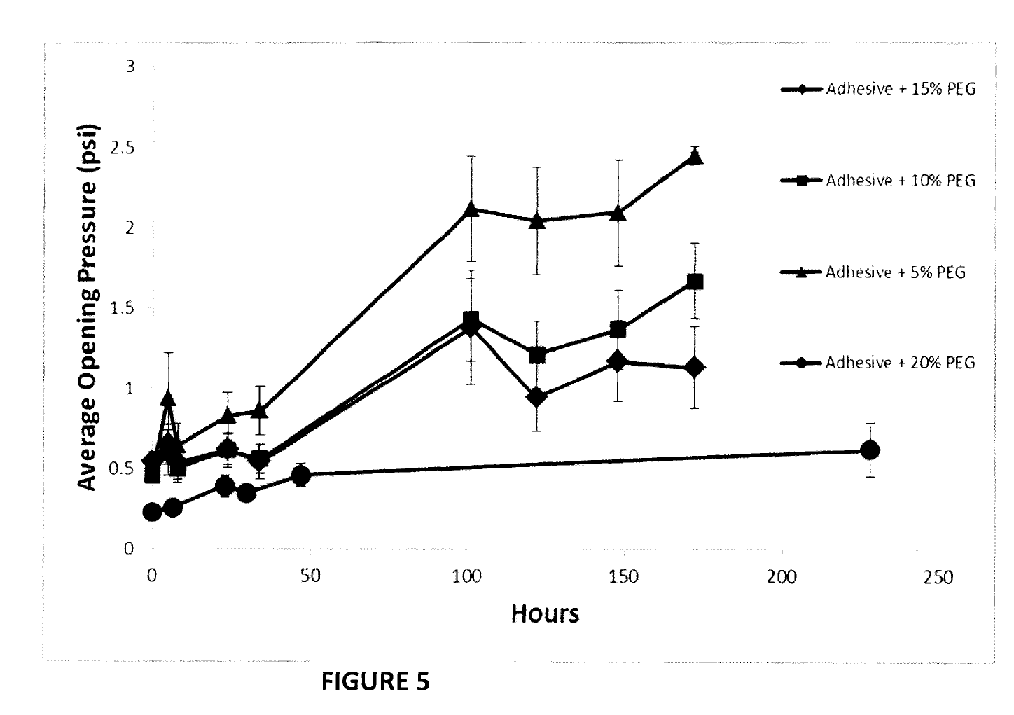

With reference now to FIG. 5, there is shown experimental data for sample valves constructed in accordance with aspects of the present inventive subject matter. In particular, for each sample type, there is shown a plot of the average opening pressure (in pound per square inch (psi)) versus time (in hours). In this case, there were four types of sample valves tested with different compositions of material located in the region 24a. The material in each case was an emulsion-based adhesive with poly(ethylene glycol) (PEG) (having a number average molecular weight of 200) added thereto to retard the rate of increase in the opening pressure (ΔPₒ). As shown, the four sample types vary by the amount of PEG added in each case (namely, 5%, 10%, 15% and 20%). The percentages in these instances refer to the percentage of PEG present in a mixture of PEG and a 30% solids formulation of adhesive. For example, the 20% PEG sample means that the weight of the PEG is ⅕^{th} of the total mixture, and so on.

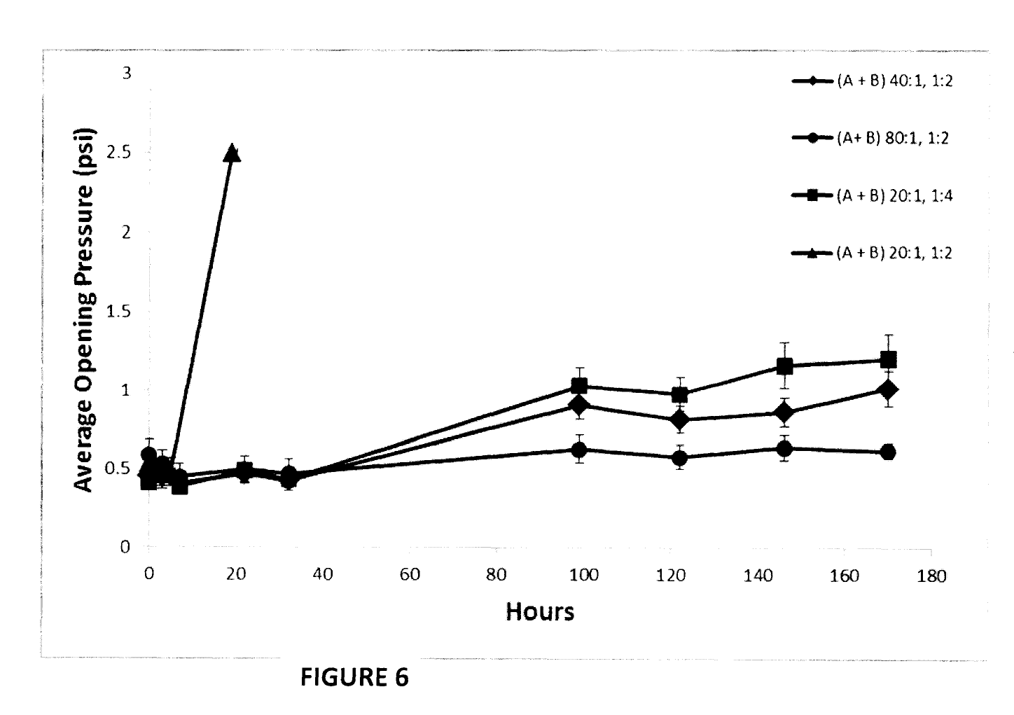

With reference now to FIG. 6, there is shown experimental data for other sample valves constructed in accordance with aspects of the present inventive subject matter. In particular, for each sample type, there is shown a plot of the average opening pressure (in psi) versus time (in hours). In this case, there were four types of sample valves tested with different compositions of material located in the region 24a. This time the material comprised a two part base-catalyst silicone system. The sample types in this case were differentiated by varying the ratio of base (part A) to catalyst (part B), and by varying an amount of a polydimethylsiloxane (PDMS) diluent (having a viscosity of 100 centipoise (cPs)). The ratios shown in the graph legend are as follows: Base:Catalyst, (Base+Catalyst):PDMS diluent. In other words, for the top sample type (represented by diamond shaped data points), the base to catalyst ratio is 40 to 1, while the ratio of base plus catalyst combined to PDMS diluent is 1 to 2; and so on for the other sample types.

While the valve 100 and/or the various layers 10 and/or 20 have been shown as generally triangular in shape, it should be understood that other configurations and/or shapes are acceptable. Likewise, while the opening or hole 12 has been shown at a corner of the triangular shapes, other arrangements and/or locations for the hole are possible. Moreover, while the base layer 10 has been illustrated with one hole 12, and one path/channels 24 is defined therefrom to a periphery of the valve 100, it is to be appreciated that more holes 12 may be included in the base layer 10 with similarly arranged corresponding channels extending therefrom. Additionally, while no holes have been shown in the top layer 30, it is to be appreciated that the top layer 30 may optionally be provisioned with one or more apertures, opening or holes and one or more of the channels 24 may extend thereto as opposed or in addition to extending to the periphery of the valve 100. Furthermore, other intermediate layers may be arranged within the valve 100 between the base and top layers 10 and 20, the intermediate layers helping to further define a tortuous, straight and/or other like path or channel through the valve.

In the illustrated embodiments, the aperture, opening and/or hole 12 is shown as circular. Nevertheless, in other suitable embodiments, the hole 12 and/or any other holes may have different geometrical shapes or may be merely slits or other suitable perforations or patterns of slits and/or patterns of perforations. Additionally, in the illustrated embodiments, the perimeters or peripheries of the various layers are aligned with one another and the layers of the multi-layer construction are substantially juxtapositioned on one another. However, it is contemplated that the multiple layers may be splayed slightly out of alignment from one another or may be positioned so to accommodate different packaging, designs and/or applications as desired.

Additionally, the valve 100 has been described for use in connection with packaging for roasted coffee and/or the like. However, it is to be appreciated that the valve 100 may be used in other applications and/or with packaging for other materials which may create pressure changes or variations within the packaging, e.g., due to matter phase changes or chemical or physical reactions experienced by the package contents for one reason or another. For example, during shipping or other transportation, packaged baby wipes or the like may experience temperature changes which result in a liquid-to-gas phase change of material contained in the baby wipes. The generated gas trapped in the package can alter the interior pressure. Accordingly, the valve 100 can be useful to relieve such a pressure build-up. Likewise, packaged concrete may undergo pressure altering reactions and the valve 100 can be useful to regulate the interior package pressure in this case.

In short, while aspects of the inventive subject matter herein have been described in connection with exemplary and/or other embodiments, it will be apparent to those of ordinary skill in the art that the invention is not to be limited to the disclosed embodiments, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

What is claimed is:

1. A one-way valve comprising:
a plurality of layers arranged one over another; and
a path extending through said layers;
wherein said valve selectively opens to permit a flow through the valve via said path in response to a pressure differential on opposing sides of the valve being sufficient to open said valve, wherein the pressure differential sufficient to open the valve dynamically varies over time.

2. The valve of claim 1, wherein a first pressure differential sufficient to open the valve at a first time is in the range of approximately 0.01 psi to approximately 0.40 psi, and second pressure differential sufficient to open the valve at a second time different from the first time is in the range of approximately 0.41 psi to approximately 15 psi.

3. The valve of claim 2, wherein an amount of time which elapses between the first time and the second time is in the range of approximately 1 hour to approximately 28 days.

4. The valve of claim 2, wherein an amount of time which elapses between the first time and the second time is in the range of approximately 5 hours to approximately 14 days.

5. The valve of claim 1, further comprising:
a material arranged in the path, said material experiencing a change over time which in turn alters how much pressure differential is sufficient to open the valve.

6. The valve of claim 5, wherein the change experienced by the material is a phase change.

7. The valve of claim 5, wherein the change experienced by the material is a change in viscosity.

8. The valve of claim 5, wherein the change experienced by the material is a change in crosslink density.

9. The valve of claim 7, wherein the material is a multi-part material including a first part, a crosslinker and a catalyst, wherein the material has a first viscosity and over time parts thereof react to achieve a second viscosity greater than the first viscosity.

10. The valve of claim 6, wherein the change experienced by the material is a change in tackiness.

11. The valve of claim 10, wherein the material is an adhesive that has a first tackiness and dries over time to achieve a second tackiness greater than the first tackiness.

12. The valve of claim 5, wherein the material is a hygroscopic material.

13. The valve of claim 12, wherein the hygroscopic material is one of xanthan gum, silica gel, poly(vinyl alcohol), crosslinked gel or partial polymer.

14. The valve of claim 13, wherein the hygroscopic material is a partial polymer with at least one of pendant groupings or side chains.

15. The valve of claim 5, wherein the change experienced by the material is at least one of initiated or encouraged by exposure to at least one of heat, light, moisture, air, diffusion or a combination of these factors.

16. A package including the valve of any of claims 1-15.

17. A valve comprising:
an opening for communicating with an interior of an article; and
a path extending from the opening to a periphery of the valve;
wherein said valve selectively opens to permit a flow through the valve via said path in response to a pressure differential on opposing sides of the valve being sufficient to open said valve, wherein the pressure differential sufficient to open the valve dynamically varies over time.

18. The valve of claim 17, wherein a first pressure differential sufficient to open the valve at a first time is in the range of approximately 0.01 psi to approximately 0.40 psi, and second pressure differential sufficient to open the valve at a second time different from the first time is in the range of approximately 0.41 psi to approximately 15 psi.

19. The valve of claim 18, wherein an amount of time which elapses between the first time and the second time is in the range of approximately 1 hour to approximately 28 days.

20. The valve of claim 18, further comprising:
a material arranged in the path, said material experiencing a change over time which in turn alters how much pressure differential is sufficient to open the valve.

21. The valve of claim 20, wherein the change experienced by the material is a phase change.

22. The valve of claim 20, wherein the change experienced by the material is a change in viscosity.

23. The valve of claim 20, wherein the change experienced by the material is a change in crosslink density.

24. The valve of claim 22, wherein the material is a multi-part material including a first part, a crosslinker and a catalyst, wherein the material has a first viscosity and over time parts thereof react to achieve a second viscosity greater than the first viscosity.

25. The valve of claim 20, wherein the change experienced by the material is a change in tackiness.

26. The valve of claim 25, wherein the material is an adhesive that has a first tackiness and dries over time to achieve a second tackiness greater than the first tackiness.

27. The valve of claim 20, wherein the material is a hygroscopic material.

28. The valve of claim 27, wherein the hygroscopic material is one of xanthan gum, silica gel, poly(vinyl alcohol), crosslinked gel or partial polymer.

29. The valve of claim 28, wherein the hygroscopic material is a partial polymer with at least one of pendant groupings or side chains.

30. The valve of claim 20, wherein the change experienced by the material is at least one of initiated or encouraged by exposure to at least one of heat, light, moisture, air, diffusion or a combination of these factors.

31. A package including the valve of any of claims 18-30.
